(19) United States
(12) Patent Application Publication
(10) Pub. No.: US 2007/0275604 A1
(43) Pub. Date: Nov. 29, 2007

(54) Connector Component System

(76) Inventors: Hermanus Franciscus Maria van Meijl, Neuss (DE); Harald Westkamp, Neuss (DE)

Correspondence Address: 3M INNOVATIVE PROPERTIES COMPANY, PO BOX 33427, ST. PAUL, MN, 55133-3427, US

(21) Appl. No.: 10/575,545

(22) PCT Filed: Sep. 7, 2004
(86) PCT No.: PCT/US04/28827

§ 371 Date: May 2, 2007

(30) Foreign Application Priority Data
Oct. 10, 2003 (EP) 03022782.1

(51) Int. Cl. H01R 9/03

(52) U.S. Cl. 439/610

(57) ABSTRACT

The connector shell for a connector component of a connector arrangement for a wire cable comprises a housing; the housing being provided with at least one first guiding element having an axis for guiding the housing along a second guiding element of a mating connector component of the connector arrangement upon coupling with the mating connector component; and at least one fastening element associated to the at least one first guiding element and substantially aligned with the axis of the at least one first guiding element for engagement with the second guiding element of the mating connector component.

### BACKGROUND OF THE INVENTION

1. Field of the Invention

The present invention relates to electrical connector components matching each other and, in particular, to a guidance and connection system for connecting, for example, a cable connector to a counterpart connector on, for example, a circuit board, face plate, backplane or the like.

2. Related Prior Art

Cables that include multiple wires, or pairs of wires, and often terminated at a connector that is used to make a reliable connection between those wires and a counterpart connector associated with, for example, a circuit board, face plate, backplane, another cable, a transceiver, or the like. The cable connector can include a number of components that secure the connector to the cable, separate and restrain the individual wires or wire pairs, feed the wires into and secure the wires to header and socket connector elements. Cable connectors of this general type, and the connector to which they are normally attached are described for example in EP-A-0 074 205, EP-A-0 311 041, EP-A-0 670 082 and EP-A-0 952 637.

To increase the number of wires that may be connected in a given location, efforts have been made to increase the pin density of the connectors so that, for example, the spacing between adjacent pins (and the portions that receive the pins) is decreased. This can, however, lead to bending of the pins or even to the insertion of one or more pins into the incorrect pin receiving portions if the two connectors are not properly aligned before they are mated.

U.S. Pat. No. 5,647,758 relates to an electrical connector assembly that provides alignment of a plug connector and a receptacle connector in a manner that would eliminate the possibility of damage to the terminals and the connector components. It includes one connector component that has two screw-receiving cavities, and another connector component that has two engagement screws. Each engagement screw has a projecting guide pin that extends beyond the threaded portion of that screw, to provide a pair of alignment members that are received within the connector cavities. By inserting first the projecting guide pins into the connector cavities, and then screwing the threaded engagement screws into the connector cavities, the connectors are supposed to be aligned and secured together.

Although the known connector appears to provide an alignment feature between two connector components, it introduces another potential problem. The projecting guide pins must bypass the threaded portions of the connector cavities each time they are inserted, before the engagement screws can be screwed into the connector cavities. Repeated contact between the guide pins and the threads of the engagement screws can be expected to damage the threads, which can in turn make it difficult or impossible to screw the threads into the connector cavities. Moreover, the guide pins are arranged with some minimum play which results in the possibility of some tilt movement which in turn affects the guiding function of the component.

In view of these and other potential difficulties, it would be desirable to provide a connector arrangement in which the electrical contact elements of one connector component are reliably aligned with electrical contact elements of the other mating connector component prior to engagement, and the alignment or guidance is reliably working and requires merely little space so that most of the connector component space can be used for the contact elements resulting in a high number of contact elements per space unit.

### SUMMARY OF THE INVENTION

The present invention provides a connector shell for a connector component of a connector arrangement for a wire cable comprising:

a housing;

the housing being provided with at least one first guiding element having an axis for guiding the housing along a second guiding element of a mating connector component of the connector arrangement upon coupling with the mating connector component; and

at least one fastening element associated to the at least one first guiding element and substantially aligned with the axis of the at least one first guiding element for engagement with the second guiding element of the mating connector component.

According to a first aspect of the invention there is provided a connector shell having guiding and fastening features all included in one part of the shell and axially aligned with each other. The guiding feature also serves for fastening the fastening feature so that the connector shell is securely mounted to the mating connector component of the connector arrangement.

The guiding features comprises a first guiding element included in the connector shell (i.e. within or outside the housing) and a second guiding component affixed to the mating connector component. Preferably, the first guiding element comprises a female element like a sleeve, a receiving channel or the like for receiving a male guiding element like a pin, a bolt or the like. The male guiding element which is the second guiding element penetrates into the female guiding element when the connector shell and the mating connector component are coupled to each other for making electrical contact between the individual contact elements of the two connector components (connector shell and mating component). It is also possible that the first guiding element is a male part and the second guiding element is a female part.

The fastening element can be engaged with the second guiding element for fixing the shell to the mating connector component. Basically, the orientation of the fasting element relative to the axis of the first guiding element. is not limited to any angle. For example, the fastening element can be oriented substantially perpendicular to the longitudinal extension of the guiding elements. However, with regard to space limitations it is preferred that the fastening element substantially is axially aligned with the first guiding element (and, accordingly, the second guiding element).

To each first guiding element an individual fastening element is associated. Typically, a connector shell comprises two first guiding elements located at opposite ends of the shell, with the electrical contact element or elements of the connector shell arranged between the first guiding elements.

The type of mechanical fastening element is not essential for the invention with regard to space used for the fastening element. For example, the fastening element can be a snap fit element snap fitable with a receiving portion of the second guiding element. Accordingly, it is possible that the fastening element is provided with a grip portion for gripping to a complementary portion of the second guiding element. or that the fastening element is provided with a portion to be gripped by a complementary portion of the second guiding element. Such a portion of the fastening element can be a ball section or the like.

However, it is preferred to use a screw as the fastening element to be in screw engagement with the second guiding element. Such a fastening element can be easily manufactured and works reliably.

Irrespective of the type of mechanical fastening element used it is preferred to have the fastening element extending through a passageway in at least one of the housing portion and the first guiding element of the connector shell. The passageway can be a bore or a channel built by two half channels each provided in one half of the shell if its housing comprises two halves.

In order to not lose the fastening element when not used for fixing the connector shell to the mating connector component it is preferred that the fastening element comprises thickened portions located at opposite ends of the passageway. Externally from the housing or first guiding element an operating end of the fastening element is arranged for manipulating the fastening element manually or by a tool for engaging it with and disengaging it from the second guiding element. Typically, for improving manual operation of the fastening element when comprising a screw, the operating end of the fastening element is provided with a structured surface.

In case of the fastening element including a screw, this screw can be provided with either an external thread (for engagement with an internal thread of a receiving bore or other space of the second guiding element) or an internal thread (for engagement with an external thread of a receiving pin of the second guiding element).

According to another aspect of the present invention there is provided a mating connector component for connecting to the connector shell comprising at least one second guiding element along which the at least one first guiding element of the housing of the connector shell is guidable, the second guiding element comprising a receiving portion for receiving a portion of the fastener element of the connecting shell.

In accordance with a further aspect of the present invention there is provided a connector arrangement comprising a connector shell and a mating connector both having the fastening and guiding features as discussed above.

Finally, the present invention also comprises a connector shell as defined above including at least one pair of first and second guiding elements wherein the second guiding element can be affixed (i.e. by screwing) to the mating connector component.

### BRIEF DESCRIPTION OF THE DRAWINGS

Some of the above indicated and other more detailed aspects of the invention will be described in the following description and partially illustrated in the drawings. As used herein, like numerals throughout the various figures represent the same or equivalent features of the present invention. In the drawings:

FIG. 1 is a side view of a connector arrangement showing a connector shell component mounted to a mating connector component design as a face plate,

FIG. 2 is an enlarged sectional view of the area of FIG. 1 encircled at II for showing the fastening feature, and

FIG. 3 is a sectional view similar to that of FIG. 2 but with the fastening element not yet in fastening engagement with the second guiding element of the face plate.

### DESCRIPTION OF A PREFERRED EMBODIMENT OF THE INVENTION

The present invention includes, in one embodiment, a connector arrangement or assembly 10 including two connector components 12,14 of the general type described above. The connector components 12,14 cooperate to interconnect, for example, cabled wires to a face plate using interconnecting pins and pin receiving portions corresponding to each of the wires such as socket and header or edge mounted connector parts as basically known to those skilled in the art. In the present invention, the guiding features of the connector components are integrated with the fastening features, so that the connector components can be reliably aligned and repeatedly connected to each other without damage, while using a minimum amount of space in the area adjacent the connector. These and other aspects and features of the present invention will be described in greater detail below.

The connector components may as noted above be provided on the end of a cable, or on a circuit board, face plate, backplane, transceiver, or any other location at which wires are terminated or interconnected or both. For example, the one connector component is a connector shell as used in the telecommunication field for high speed signal transmission as discussed for example in EP-A-0 074 205, EP-A-0 311 041, EP-A-0 670 082, and EP-A-0 952 637 the disclosure thereof being incorporated herein by reference.

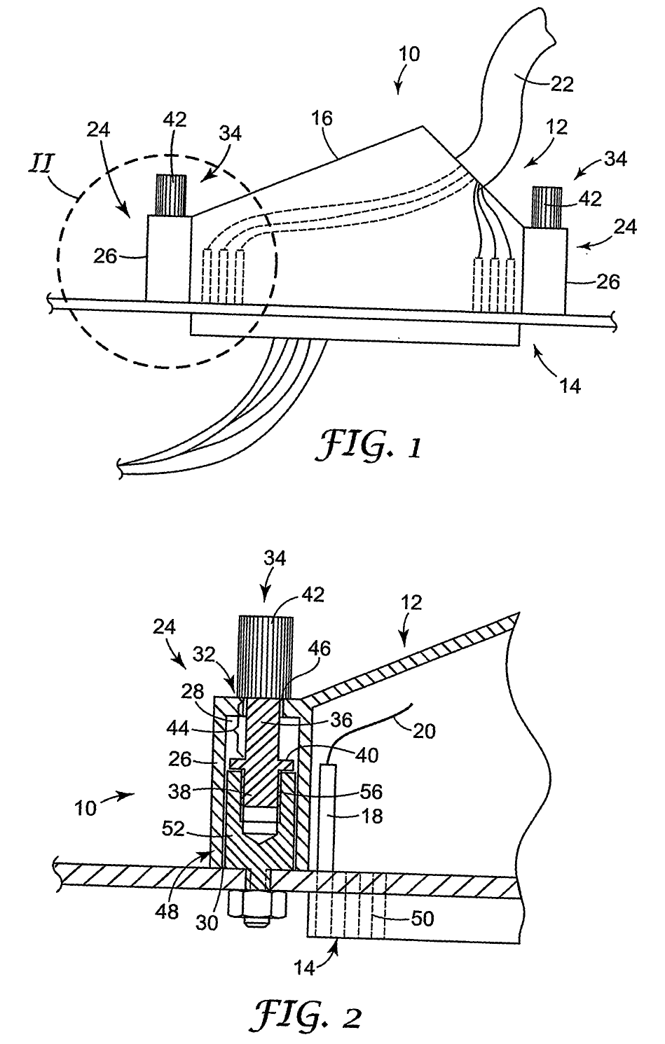

In one aspect of the present invention, the connector components includes or is positioned adjacent to a projecting guiding component that cooperates with a female guiding component associated with the other connector component. In the embodiment shown in FIGS. 1 to 3 the connector shell 12 comprises a housing 16 made of any type of material but preferably comprise metal. Within the housing 16 a multitude of first contact elements 18 are arranged in an array including at least one line and, preferably, several lines. These contact elements 18 are connected to the individual wires 20 of cable 22 which can be a copper wire, optical fibers or any other wire used to transmit signals in e.g. the telecommunication or computer industry. The contact elements 18 can be e.g. SCI connectors (shielded controlled impedance connectors) like those described in U.S. Pat. No. 5,184,965, DE-C-41 16 666, and DE-C-41 16 168, or optical connectors as basically known by those skilled in the art.

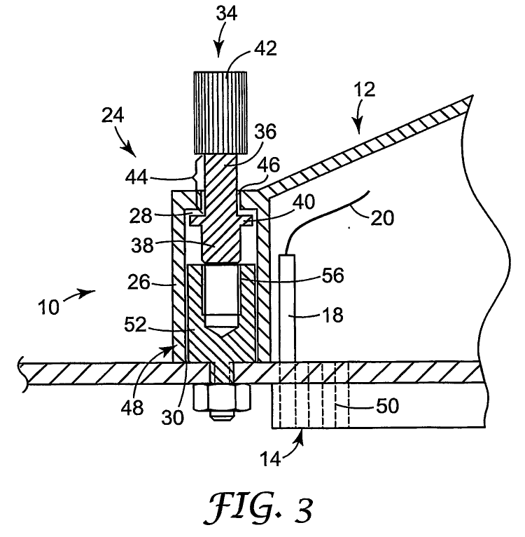

At the lateral sides of the housing 16 two first female guiding elements 24 are located being integral or single part with the housing 16. Each female guiding element 24 comprises a sleeve 26 defining a receiving channel 28 with a receiving opening 30 and an end 32 opposite thereto. A fastening element 34 extends through the upper end 32 of the female guiding element 24. This fastening element 34 includes a shaft 36 having a threaded end 38, a thickened portion 40 and an operating end 42 opposite to the threaded end 38. That part 44 of the shaft 36 between its thickened portion 40 and the operating end 42 extends through a passageway 46 in the end 32 of the sleeve 26 of the female guiding element 24. The part 44 of the shaft 36 has a larger extension than the passageway 46 so that a clearance is formed as can be seen in FIGS. 2 and 3.

Female second guiding elements 48 are mounted to the face plate (mating connector component). In this embodiment, the male guiding elements 48 are screwed to the face plate 14. However, other mechanical securing means can be used as being evident to those skilled in the art.

The face plate 14 provides a mating connector part like a header 50 or the like having pin-like contact elements 52 for making electrical connection with the female contact elements 18 of the connector shell 12. Other types of mating connector parts than the header 50 can also be used.

In operation, the connector shell 12 for connection purposes is pushed against the face plate 14. At this time, the female guiding elements 44 are receiving the male guiding elements 48. This assists in precisely moving the connector shell further towards the face plate 14 allowing the contact elements 18 of the connector shell 12 to become aligned with the contact elements 50 at the face plate 14. The male guiding elements 48 each comprise a bolt, pin or post 52 having a receiving opening 54 facing the fastening element 34 and provided with an internal thread 56. The tolerance between the bolts 52 of the male guiding elements 48 and the channels 28 of the female guiding elements 24 is preferably selected such that the vertical tilting angle allowed at the maximum is substantially not more than ±4 degree.

The guiding feature of the present invention allows precise alignment of the contact elements prior to their mechanically (and, accordingly, electrically) contacting them. This helps to prevent damages and allows for reliable electrical contact. Moreover, the fastening feature realized in combination with the guiding features assists in reducing the space needed resulting in an overall compact design of the connector assembly 10.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1-24. (canceled)

25. A connector shell for a connector component of a connector arrangement for a wire cable comprising:
a housing including first contact elements,
the housing being provided with at least one first guiding element having an axis for guiding the housing along a second guiding element of a mating connector component of the connector arrangement upon coupling with the mating connector component allowing alignment of the first contact elements with mating second contact elements of the mating connector component prior to their mechanical contact with each other, and
at least one fastening element associated to the at least one first guiding element and substantially aligned with the axis of the at least one first guiding element for engagement with the second guiding element of the mating connector component.

26. The connector shell according to claim 1, wherein the fastening element is secured to at least one of the housing and the at least one first guiding element of the housing.

27. Connector shell according to claim 1, wherein the fastening element extends through a passageway formed in a portion of the at least one first guiding element of the housing for engagement with the second guiding element of the mating connector component.

28. Connector shell according claim 3, wherein the passageway is axially aligned with the at least one first guiding element.

29. Connector shell according to claim 1, wherein the fastening element comprises a shaft extending through a passageway formed in a portion of the at least one first guiding element of the housing, the shaft comprising a head and a thickened portion both located outside of and adjacent to opposite ends of the passageway.

30. Connector shell according to claim 7, wherein the fastening element is axially movable within the passageway by a distance defined by the abutment of each of the head and the thickened portion of the fastening element to the respective opposite ends of the passageway.

31. Connector shell according to claim 1, wherein the at least one first guiding element comprising a receiving channel for receiving the second guiding element of the mating connector component.

32. Connector shell according to claim 9, wherein the receiving channel comprises a receiving opening and an end arranged opposite thereto and through which the passageway for the fastening element extends.

33. Connector shell according to claim 1, wherein the housing comprises two first guiding elements at opposite sides of the housing and wherein to each first guiding element a fastening element is associated.

34. Connector shell according to claim 1, wherein the second guiding element of the mating connector component comprises a receiving portion for receiving a portion of the fastening element associated to the at least one first guiding element for fastening the housing to the second guiding element of the mating connector component.

35. Connector shell according to claim 12, wherein the receiving portion comprises a receiving bore.

36. Connector shell according to claim 12, wherein the receiving portion comprises a receiving pin.

37. A mating connector component for connecting to the connector shell of any one of the preceding claims, comprising at least one second guiding element along which the at least one first guiding element of the housing of the connector shell is guidable, the second guiding element comprising a receiving portion for receiving a portion of the fastener element of the connecting shell.

38. The connector component according to claim 17, wherein the receiving portion comprises a receiving bore.

39. The connector component according to claim 17, wherein the receiving portion comprises a receiving pin.

40. The connector component according to claim 17, further comprising a housing and/or a face plate, in particular a backplane to which the at least one second guiding element is attached or attachable.

41. The connector component according to claim 1, further comprising at least one electrical contact element to be electrically connected to a contact element of the connector shell.
